(19) United States
(12) Patent Application Publication
(10) Pub. No.: US 2020/0198676 A1
(43) Pub. Date: Jun. 25, 2020

(54) VEHICLE STARTING SYSTEM, REMOTE CONTROL SYSTEM, INTEGRATED TRAIN MANAGEMENT SYSTEM, AND AUTOMATIC TRAIN CONTROLLER

(71) Applicant: Mitsubishi Electric Corporation, Chiyoda-ku, Tokyo (JP)

(72) Inventors: Ryosuke GOTO, Tokyo (JP); Yoshihito TAKIGAWA, Tokyo (JP)

(73) Assignee: Mitsubishi Electric Corporation, Chiyoda-ku, Tokyo (JP)

(21) Appl. No.: 16/621,047

(22) PCT Filed: Jun. 16, 2017
(86) PCT No.: PCT/JP2017/022393

§ 371 Date: Dec. 10, 2019

(51) Int. Cl. B61L 27/00; B61C 3/00; B61L 27/04; B60L 5/18; B60M 3/00

(52) U.S. Cl. CPC B61L 27/0005; B61C 3/00; B61L 27/04; B61C 17/06; B60M 3/00; B61L 2201/00; B61L 2205/00; B60L 5/18

(57) ABSTRACT

A vehicle starting system according to the present invention includes: an ATC as an automatic train controller that, on the basis of a start instruction received from an OCC as a central command device on the ground, starts a TCMS as an integrated train management system mounted on a train; and the TCMS performs control to supply power to a first vehicle device, and further performs control to supply power to a second vehicle device by raising a pantograph and then closing a VCB as a vacuum circuit breaker, and converting a voltage of alternating-current power acquired from an overhead contact line via the pantograph and the VCB.

### FIELD

The present invention relates to a vehicle starting system, a remote control system, an integrated train management system, an automatic train controller, and a vehicle starting method.

### BACKGROUND

Conventionally, traveling of trains has been automatically controlled by operation management apparatuses on the ground. Specifically, such an operation management apparatus is connected to an on-board transmission device via a wireless network, and transmits a command for controlling a train. A train travel control function unit on the train controls traveling of the train on the basis of the command transmitted from the operation management apparatus. Such a technique is disclosed in Patent Literature 1.

### CITATION LIST

### Patent Literature

Patent Literature 1: Japanese Patent Application Laid-open No. 2013-132980

### SUMMARY

### Technical Problem

However, according to the above-described conventional technique, the operation management apparatus cannot start a system on the train when starting operation of the train. Therefore, there is the following problem: when starting the operation of the train, it is necessary for an operator to start a train system by pressing a start button on a cab of a vehicle, which is troublesome.

The present invention has been made in view of the above, and an object thereof is to provide a vehicle starting system that receives an instruction from the ground to make a train operable.

### Solution to Problem

To solve the above problems and achieve the object, a vehicle starting system according to the present invention includes: an automatic train controller to start an integrated train management system mounted on a train on a basis of a start instruction received from a central command device on ground; and the integrated train management system to perform control to supply power to a first vehicle device, and to further perform control to supply power to a second vehicle device by raising a pantograph and then closing a circuit breaker, and converting a voltage of alternating-current power acquired from an overhead contact line via the pantograph and the circuit breaker.

### Advantageous Effects of Invention

According to the present invention, the vehicle starting system achieves an effect of receiving an instruction from the ground to make a train operable.

### BRIEF DESCRIPTION OF DRAWINGS

FIG. 1 is a diagram illustrating an example configuration of a remote control system.

FIG. 2 is a diagram illustrating an example of a power supply path in a vehicle starting system.

FIG. 3 is a block diagram illustrating an example configuration of the remote control system.

FIG. 4 is a sequence diagram illustrating operations by the remote control system performed before a train is made operable.

FIG. 5 is a sequence diagram illustrating operations by the remote control system performed before operation of the train is stopped.

FIG. 6 is a flowchart illustrating operations by a TCMS performed before the train is made operable.

FIG. 7 is a flowchart illustrating operations by the TCMS performed before operation of the train is stopped.

FIG. 8 is a flowchart illustrating operations by an ATC performed before the train is made operable.

FIG. 9 is a flowchart illustrating operations by the ATC performed before operation of the train is stopped.

FIG. 10 is a diagram illustrating an example in which a processing circuit included in the TCMS is configured with a processor and a memory.

FIG. 11 is a diagram illustrating an example in which the processing circuit included in the TCMS is configured with dedicated hardware.

### DESCRIPTION OF EMBODIMENTS

Hereinafter, a vehicle starting system, a remote control system, an integrated train management system, an automatic train controller, and a vehicle starting method according to an embodiment of the present invention will be described in detail with reference to the drawings. The present invention is not limited to the embodiment.

### Embodiment

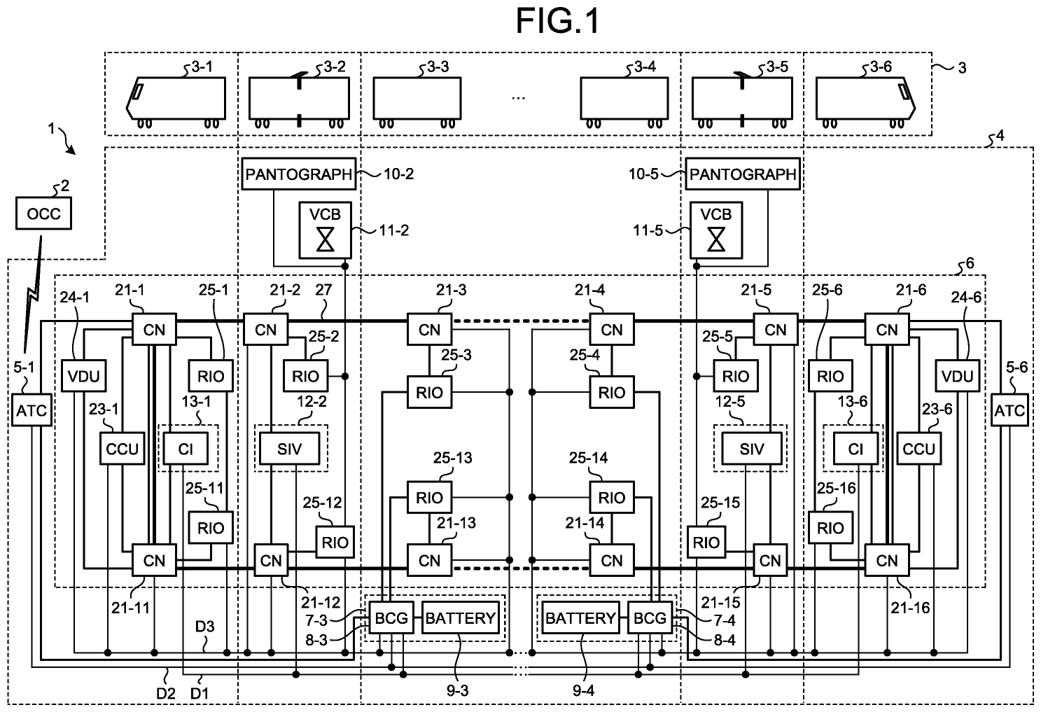

FIG. 1 is a diagram illustrating an example configuration of a remote control system 1 according to an embodiment of the present invention. The remote control system 1 includes an operation control center (OCC) 2 and a vehicle starting system 4. The OCC 2 is a central command device installed on the ground. The OCC 2 receives an operation from a user, for example, an observer, and transmits a start instruction to the vehicle starting system 4 mounted on a train 3 when operation of the train 3 is started. The OCC 2 receives an operation from the observer and transmits a stop instruction to the vehicle starting system 4 when the operation of the train 3 is ended. The vehicle starting system 4 mounted on the train 3 makes the train 3 operable on the basis of the start instruction received from the OCC 2. The vehicle starting system 4 stops the train 3 on the basis of the stop instruction received from the OCC 2.

In FIG. 1, the vehicle starting system 4 is located outside vehicles 3-1 to 3-6 constituting the train 3, actually however, the vehicle starting system 4 is located inside the train 3. The numbers at the end of reference numerals of respective components indicate vehicles on which the respective components are mounted. The same applies to components described later. The vehicles on which respective components are mounted are merely examples, and are not limited to the examples of FIG. 1.

The vehicle starting system 4 includes: automatic train controls (ATCs) 5-1 and 5-6; a train control and monitoring system (TCMS) 6; direct-current power supplies 7-3 and 7-4; pantographs 10-2 and 10-5; vacuum circuit breakers (VCBs) 11-2 and 11-5; static inverters (SIVs) 12-2 and 12-5; and converter inverters (CIs) 13-1 and 13-6.

The ATCs 5-1 and 5-6 are automatic train controllers that: start the TCMS 6 mounted on the train 3 when receiving the start instruction by wireless communication from the OCC 2; and stop supply of power to the TCMS 6 when receiving the stop instruction from the OCC 2. The ATCs 5-1 and 5-6 have the same configuration. When the ATCs 5-1 and 5-6 are not distinguished from each other, they may be referred to as the ATC 5. FIG. 1 illustrates an example in which the ATC 5-1 receives the start instruction and the stop instruction from the OCC 2 and controls start and stop of the TCMS 6. However, the ATC 5-6 can receive the start instruction and the stop instruction from the OCC 2, and control the start and stop of the TCMS 6, as well. Hereinafter, as illustrated in FIG. 1, a case where the ATC 5-1 receives the start instruction and the stop instruction from the OCC 2 will be described as an example.

The TCMS 6 is an integrated train management system that, when started by the control of the ATC 5, supplies power to each vehicle device to power ON each vehicle device, thereby making the train 3 operable. In addition, when the TCMS 6 receives the stop instruction from the OCC 2 via the ATC 5, the TCMS 6 stops supply of power to each vehicle device to power OFF each vehicle device, and also powers OFF the TCMS 6 to stop the train 3.

The TCMS 6 includes: communication nodes (CNs) 21-1 to 21-6 and 21-11 to 21-16; central control units (CCUs) 23-1 and 23-6; video display units (VDUs) 24-1 and 24-6; and remote input/output units (RIOs) 25-1 to 25-6 and 25-11 to 25-16. In the TCMS 6, respective components are connected within a vehicle or between vehicles by an Ethernet (registered trademark) network.

The CNs 21-1 to 21-6 and 21-11 to 21-16 constitute a TCMS network 27 that meets the Ethernet standard. As indicated by a thick line in FIG. 1, the TCMS network 27 is a network having a loop configuration. The CNs 21-1 to 21-6 and 21-11 to 21-16 are first communicators that operate as hubs. The CNs 21-1 to 21-6 and 21-11 to 21-16 may have the same configuration or different configurations. When the CNs 21-1 to 21-6 and 21-11 to 21-16 are not distinguished from each other, they may be referred to as the CN 21.

The CCUs 23-1 and 23-6 are first controllers that control an operation of each component of the TCMS 6 and monitor each vehicle device connected to the TCMS 6 to control an operation thereof. One of the CCUs 23-1 and 23-6 is mounted on a vehicle that is a leading vehicle of the train 3, and the other thereof is mounted on a vehicle that is a trailing vehicle of the train 3. The CCUs 23-1 and 23-6 have the same configuration. When the CCUs 23-1 and 23-6 are not distinguished from each other, they may be referred to as the CCU 23.

The VDUs 24-1 and 24-6 are display units that display, to a user, for example, a train operator, information necessary for operation of the train 3. The VDUs 24-1 and 24-6 are mounted on a vehicle that is a leading vehicle or a trailing vehicle of the train 3. The VDUs 24-1 and 24-6 have the same configuration. When the VDUs 24-1 and 24-6 are not distinguished from each other, they may be referred to as the VDU 24.

The RIOs 25-1 to 25-6 and 25-11 to 25-16 are signal input/output units that input/output signals to and from each vehicle device. The RIOs 25-1 to 25-6 and 25-11 to 25-16 may have different configurations depending on a vehicle device to be connected. When the RIOs 25-1 to 25-6 and 25-11 to 25-16 are not distinguished from each other, they may be referred to as the RIO 25.

In the TCMS 6, the CCU 23 communicates with a vehicle device via one or more CNs 21; or, one or more CNs 21 and RIOs 25.

The direct-current power supply 7-3 includes a battery charger (BCG) 8-3 and a battery 9-3. The direct-current power supply 7-4 includes a battery charger (BCG) 8-4 and a battery 9-4. When the direct-current power supplies 7-3 and 7-4 are not distinguished from each other, they may be referred to as the direct-current power supply 7; when the BCGs 8-3 and 8-4 are not distinguished from each other, they may be referred to as the BCG 8; and when the batteries 9-3 and 9-4 are not distinguished from each other, they may be referred to as the battery 9. As described in more detail below, the BCG 8 converts low-voltage alternating-current power, which is obtained by converting high-voltage alternating-current power obtained from an overhead contact line, into direct-current power, and charges the battery 9. In the direct-current power supply 7, with the use of the direct-current power charged in the battery 9, the BCG 8 always supplies power to a power line D2 that supplies power to the ATC 5. With the use of the direct-current power charged in the battery 9, the BCG 8 supplies power to a power line D3 that supplies power to the TCMS 6 and stops the supply of power to the power line D3 on the basis of the control of the ATC 5. The power line D3 is a second power line. With the use of the direct-current power charged in the battery 9, the BCG 8 supplies power to a power line D1 that supplies power to a vehicle device, and stops the supply of power to the power line D1 on the basis of the control of the CCU 23. The power line D1 is a first power line.

The pantographs 10-2 and 10-5 are current collectors that are controlled to be raised by the CCU 23. Specifically, current collecting portions thereof to be brought into contact with an overhead contact line (not illustrated) are pressed against the overhead contact line, thereby collecting alternating-current power from the overhead contact line. When the pantographs 10-2 and 10-5 are not distinguished from each other, they may be referred to as the pantograph 10.

The VCBs 11-2 and 11-5 are circuit breakers, specifically, vacuum circuit breakers that perform, between the pantograph 10 and a main transformer described later, connection and disconnection of the pantograph 10 and the main transformer. When an abnormality in a vehicle device in the vehicle, an abnormal voltage in the overhead contact line, or the like is detected, the VCBs 11-2 and 11-5 disconnect the pantograph 10 and the main transformer from each other, thereby interrupting high-voltage alternating-current power from the overhead contact line. When the VCBs 11-2 and 11-5 are not distinguished from each other, they may be referred to as the VCB 11.

The SIVs 12-2 and 12-5 are inverters that convert high-voltage alternating-current power into low-voltage alternating-current power. The SIVs 12-2 and 12-5 are first vehicle devices. When the SIVs 12-2 and 12-5 are not distinguished from each other, they may be referred to as the SIV 12.

The CIs 13-1 and 13-6 convert high-voltage alternating-current power into a voltage used in a vehicle device such as a motor that drives the wheels of a train. The CIs 13-1 and 13-6 are first vehicle devices. When the CIs 13-1 and 13-6 are not distinguished from each other, they may be referred to as the CI 13.

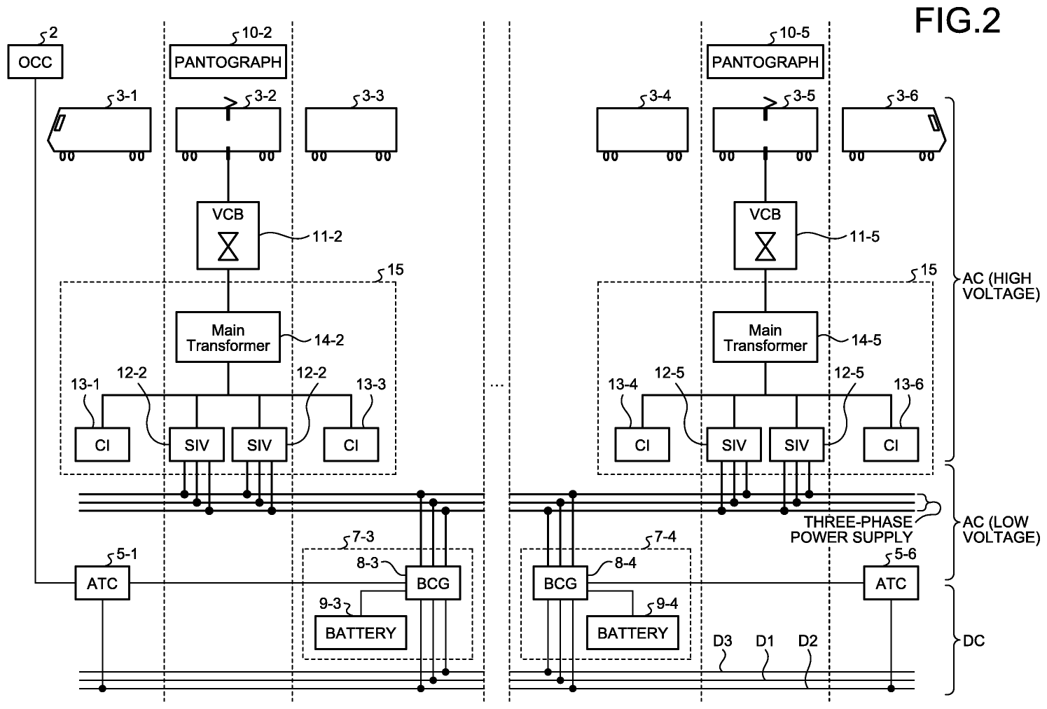

FIG. 2 is a diagram illustrating an example of a power supply path in the vehicle starting system 4 according to the present embodiment. In FIG. 2, components of the TCMS 6 are omitted for simplicity in description. In addition, components not illustrated in FIG. 1 are added. Main transformers 14-2 and 14-5 are transformers that step down high-voltage alternating-current power collected by the pantograph 10 to a specified voltage. When the main transformers 14-2 and 14-5 are not distinguished from each other, they may be referred to as the main transformer 14. Unlike FIG. 1, FIG. 2 illustrates an example in which the CIs 13-3 and 13-4 are mounted on the vehicles 3-3 and 3-4. The CIs 13-3 and 13-4 have the same configuration as the CIs 13-1 and 13-6. An example of a redundant configuration is illustrated in which two SIVs 12 are mounted in each of the vehicles 3-2 and 3-5. The main transformer 14, the SIV 12, and the CI 13 are collectively referred to as a power converter 15.

In FIG. 2, in the train 3, the main transformer 14 acquires the high-voltage alternating-current power collected by the pantograph 10 via the VCB 11. The main transformer 14 steps down the high-voltage alternating-current power to a specified voltage and outputs the voltage to the SIV 12 and the CI 13. The SIV 12 converts the alternating-current power acquired from the main transformer 14 into low-voltage alternating-current power, and outputs the converted alternating-current power to a power line of a three-phase power supply. Similarly, the CI 13 converts the voltage of the alternating-current power acquired from the main transformer 14 and outputs the converted alternating-current power to a motor that drives the wheels, or the like. A vehicle device to which power is supplied from the SIV 12 and the CI 13 is defined as a second vehicle device. Examples of the second vehicle device include, but are not limited to, the direct-current power supply 7 and the motor described above. In the direct-current power supply 7, the BCG 8 converts the alternating-current power of the three-phase power supply into direct-current power, and charges the battery 9. The BCG 8 supplies the direct-current power obtained by converting the alternating-current power of the three-phase power supply or the direct-current power charged in the battery 9 to the power lines D1 to D3.

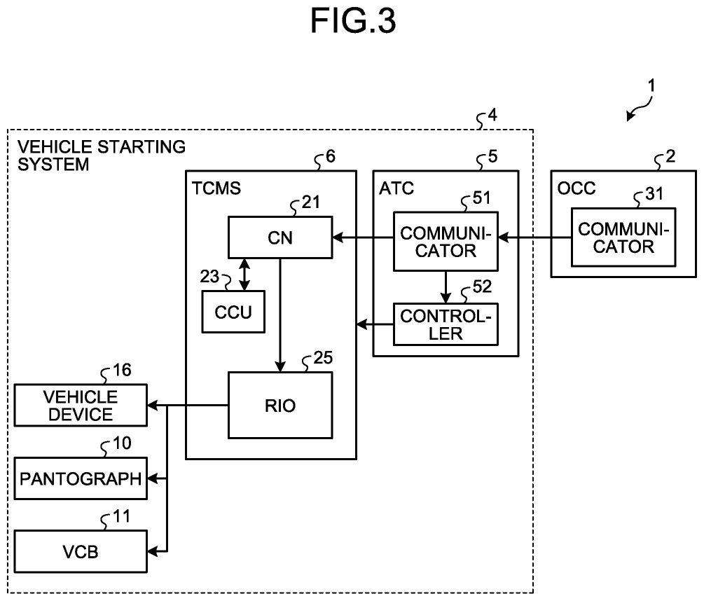

FIG. 3 is a block diagram illustrating an example configuration of the remote control system 1 according to the present embodiment. The OCC 2 includes a communicator 31 that transmits a start instruction and a stop instruction to the vehicle starting system 4. The ATC 5 includes a communicator 51 and a controller 52. The communicator 51 is a second communicator that receives a start instruction and a stop instruction from the OCC 2. The controller 52 is a second controller that, when the communicator 51 receives a start instruction, supplies power from the direct-current power supply 7 to the power line D3 that supplies power to the TCMS 6. When the communicator 51 receives a stop instruction, the controller 52 stops the supply of power from the direct-current power supply 7 to the power line D3 after the operation of the TCMS 6 is stopped.

The TCMS 6 includes the CN 21, the CCU 23, and the RIO 25. In FIG. 3, one component is illustrated for each type thereof, but as illustrated in FIG. 1, the TCMS 6 actually includes a plurality of components for each type thereof. In FIG. 3, a description of the VDU 24 is omitted. The CN 21 communicates with the communicator 51 of the ATC 5. In the TCMS 6, the CCU 23 communicates with the pantograph 10, the VCB 11, and a vehicle device 16 mounted on the train 3 via one or more CNs 21 and RIOs 25. The vehicle device 16 is a device mounted on the train 3. An example of the vehicle device 16 is the direct-current power supply 7, but is not limited thereto. As the vehicle device 16, for example, there are doors of each vehicle, and a display device that displays a stop to passengers, which are not illustrated in FIGS. 1 to 3.

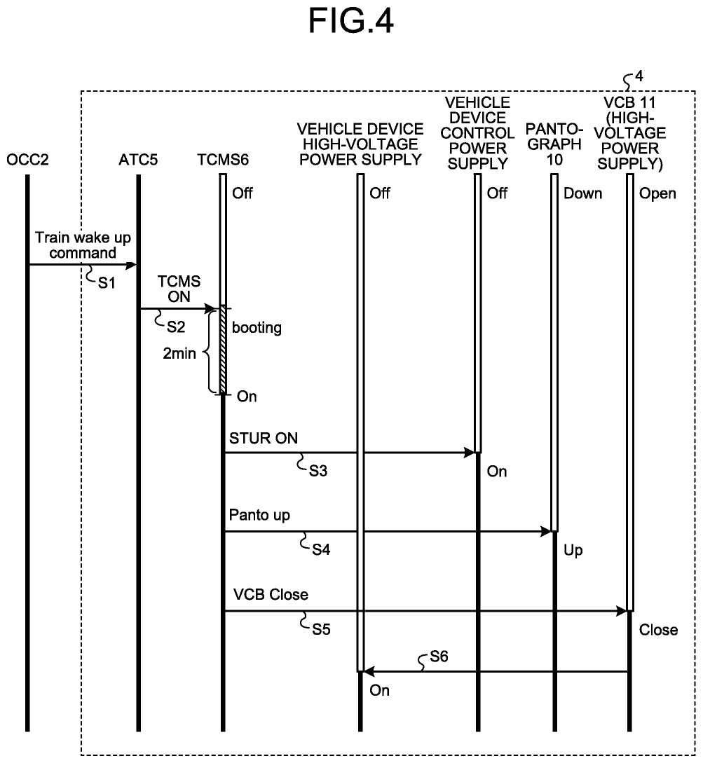

Next, operations by the remote control system 1 performed before the train 3 is made operable will be described. FIG. 4 is a sequence diagram illustrating operations by the remote control system 1 according to the present embodiment performed before the train 3 is made operable. First, the communicator 31 of the OCC 2 transmits a start instruction that instructs start of the train 3 to the ATC 5 (Step S1). In FIG. 4, the start instruction is described as “Train wake up command”. In the ATC 5, when the communicator 51 receives the start instruction, the start instruction is transferred to the controller 52. The controller 52 causes the BCG 8 of the direct-current power supply 7 to supply power to the power line D3 that supplies power to the TCMS 6 to power ON the TCMS 6 (Step S2). In the TCMS 6, when powered ON by the control of the ATC 5, the TCMS 6 starts its own system to make operations of the vehicle devices mounted on the train 3 controllable. In the TCMS 6, when a certain time, for example, about two minutes elapses after the powering ON, a system starting process ends and the operations of the vehicle devices becomes controllable.

In the TCMS 6, when the CCU 23 is started by the control of the ATC 5, the CCU 23 turns ON a vehicle device control power supply (Step S3). In FIG. 4, the operation of CCU23 is described as “STUR ON”. Specifically, the CCU 23 causes the BCG 8 of the direct-current power supply 7 to supply power to the power line D1 that supplies power to the first vehicle device via one or more CNs 21 and RIOs 25 to power ON the first vehicle device. Although the SIV 12 and the CI 13 are exemplified as the first vehicle device that receives power supply from the power line D1, they are merely examples. Examples of the first vehicle device further include other vehicle devices not illustrated.

The CCU 23 raises the pantograph 10 via one or more CNs 21 and RIOs 25, in particular, the CCU 23 raises the current collecting portion of the pantograph 10 to bring the current collecting portion into contact with the overhead contact line (Step S4). In FIG. 4, the operation of the CCU 23 is described as “Panto up”. After raising the pantograph 10, the CCU 23 closes the VCB 11, that is, puts the VCB 11 into a closed state, via one or more CNs 21 and RIOs 25 (Step S5). In FIG. 4, the operation of the CCU 23 is described as “VCB Close”. When the VCB 11 is put into the closed state, as illustrated in FIG. 2, the high-voltage alternating-current power acquired from the overhead contact line is converted into a desired voltage by the main transformer 14, the SIV 12, and the CI 13. The CCU 23 controls the main transformer 14, the SIV 12, and the CI 13 to supply power to the second vehicle device. The second vehicle device that has received the supply of power whose voltage has been converted by the main transformer 14, the SIV 12, and the CI 13 is powered ON and starts operating (Step S6). In FIG. 4, the power-ON state of the second vehicle device is represented as vehicle device high-voltage power supply On.

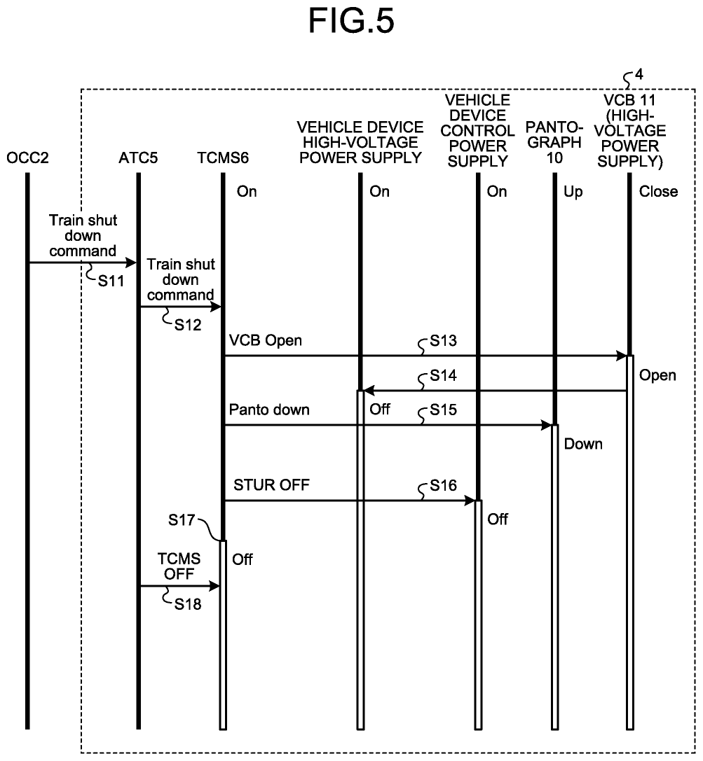

Regarding operations by the remote control system 1 performed when operation of the train 3 is stopped, processes are performed in a reverse flow to the above-described operations performed before the operation is started. FIG. 5 is a sequence diagram illustrating operations by the remote control system 1 according to the present embodiment performed before operation of the train 3 is stopped. First, the communicator 31 of the OCC 2 transmits a stop instruction that instructs to stop the operation of the train 3 to the ATC 5 (Step S11). In FIG. 5, the stop instruction is described as “Train shut down command”. In the ATC 5, when the communicator 51 receives the stop instruction, the stop instruction is transferred to the controller 52. The controller 52 transfers the stop instruction from the communicator 51 to the TCMS 6 (Step S12).

In the TCMS 6, the CCU 23 acquires the stop instruction via the communicator 51 of the ATC 5 and the CN 21. The CCU 23 opens the VCB 11, that is, puts the VCB 11 into an open state, via one or more CNs 21 and RIOs 25 (Step S13). In FIG. 5, the operation of the CCU 23 is described as “VCB Open”. When the VCB 11 is put into the open state, as illustrated in FIG. 2, the high-voltage alternating-current power acquired from the overhead contact line is no longer supplied to the main transformer 14. The CCU 23 stops conversion processes in the main transformer 14, the SIV 12, and the CI 13, and stops the supply of power to the second vehicle device. As a result, the second vehicle device that is no longer supplied with power is powered OFF (Step S14). After the VCB 11 is put into the open state, the CCU 23 lowers the pantograph 10 via one or more CNs 21 and RIOs 25, in particular, the CCU 23 lowers the current collecting portion of the pantograph 10 to separate the current collecting portion from the overhead contact line (Step S15). In FIG. 5, the operation of the CCU 23 is described as “Panto down”.

The CCU 23 turns OFF the vehicle device control power supply (Step S16). In FIG. 5, the operation of the CCU 23 is described as “STUR OFF”. Specifically, the CCU 23 causes the BCG 8 of the direct-current power supply 7 to stop the supply of power to the power line D1 via one or more CNs 21 and RIOs 25 to power OFF the first vehicle device. After the elapse of prescribed first time from completion of the process of Step S16, the CCU 23 stops the operation of the TCMS 6 including the CCU 23 and powers OFF the TCMS 6 including the CCU 23 (Step S17).

In the ATC 5, the controller 52 causes the BCG 8 of direct-current power supply 7 to stop the supply of power to the power line D3 after the operation of the TCMS 6 is stopped, that is, after the powering OFF of the TCMS 6, or after the elapse of prescribed second time from the transfer of the stop instruction to the TCMS 6 (Step S18). Note that the following formula is established: the second time>the first time.

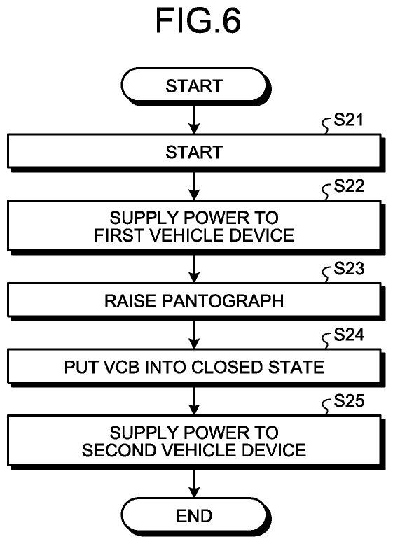

Each operation of the TCMS 6 and the ATC 5 will be described using flowcharts. FIG. 6 is a flowchart illustrating operations by the TCMS 6 according to the present embodiment performed before the train 3 is made operable. The CCU 23 is started by the control of the ATC 5 (Step S21). The CCU 23 controls the BCG 8 of the direct-current power supply 7 to supply power to the power line D1, thereby supplying power to the first vehicle device (Step S22). The CCU 23 raises the pantograph 10 (Step S23), and puts the VCB 11 into a closed state (Step S24). The CCU 23 controls operations of the main transformer 14, the SIV 12, and the CI 13, and supplies, to the second vehicle device, power acquired by converting a voltage of alternating-current power acquired from the overhead contact line (Step S25). Thus, the TCMS 6 can make the train 3 operable.

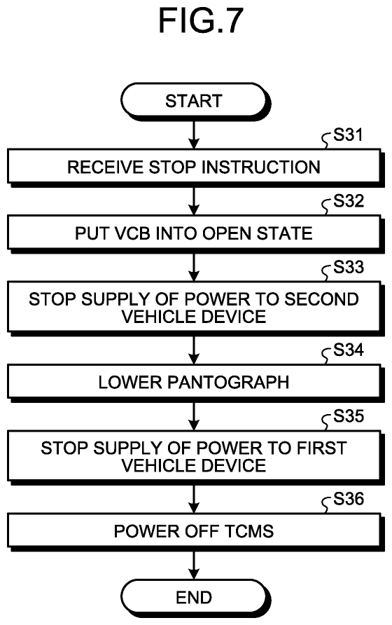

FIG. 7 is a flowchart illustrating operations by the TCMS 6 according to the present embodiment performed before operation of the train 3 is stopped. The CCU 23 receives the stop instruction transmitted from the OCC 2 via the ATC 5 and the CN 21 (Step S31). The CCU 23 puts the VCB 11 into an open state (Step S32). The CCU 23 stops the supply of power from the pantograph 10, and thus the CCU 23 stops the supply of power to the second vehicle device (Step S33). The CCU 23 lowers the pantograph 10 (Step S34). The CCU 23 controls the BCG 8 of the direct-current power supply 7 to stop the supply of power to the power line D1, thereby stopping the supply of power to the first vehicle device (Step S35). After the elapse of the first time, the CCU 23 powers OFF the TCMS 6 including the CCU 23 to stop the operation (Step S36). Thus, the TCMS 6 can put the train 3 into an operation stop state.

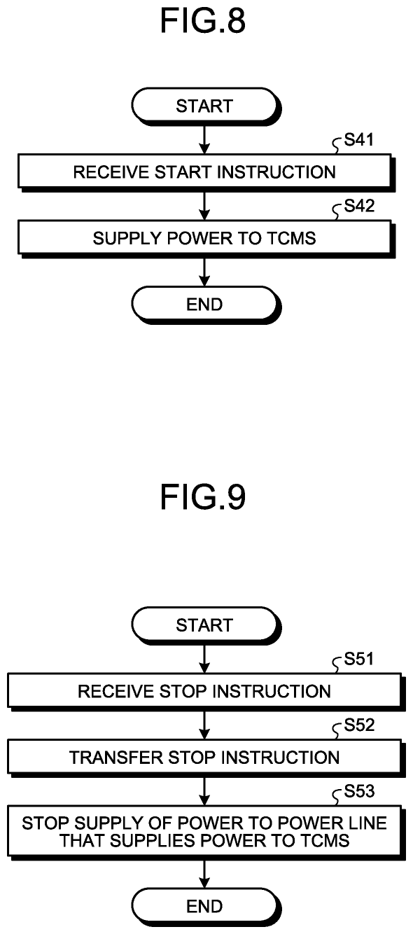

FIG. 8 is a flowchart illustrating operations by the ATC 5 according to the present embodiment performed before the train 3 is made operable. In the ATC 5, the controller 52 receives the start instruction transmitted from the OCC 2 via the communicator 51 (Step S41). The controller 52 controls the BCG 8 of the direct-current power supply 7 to supply power to the power line D3, thereby supplying power to the TCMS 6 (Step S42).

FIG. 9 is a flowchart illustrating operations by the ATC 5 according to the present embodiment performed before operation of the train 3 is stopped. In the ATC 5, the controller 52 receives the stop instruction transmitted from the OCC 2 via the communicator 51 (Step S51). The controller 52 transfers the stop instruction from the communicator 51 to the TCMS 6 (Step S52). The controller 52 causes the BCG 8 of the direct-current power supply 7 to stop the supply of power to the power line D3 after the powering OFF of the TCMS 6, or after the elapse of the prescribed second time from the transfer of the stop instruction to the TCMS 6 (Step S53).

Next, a hardware configuration of the TCMS 6 will be described. In the TCMS 6, the CN 21 is an interface circuit capable of transmitting and receiving Ethernet frames. The VDU 24 is a display such as a liquid crystal display (LCD). The RIO 25 is an RIO circuit, that is, a serial/parallel conversion circuit. The CCU 23 is realized by a processing circuit. That is, the TCMS 6 includes a processing circuit that can start the train 3 to make the train 3 operable and can power OFF the vehicle device when stopping the operation of the train 3. The processing circuit may be a memory and a processor that executes a program stored in the memory, or may be dedicated hardware.

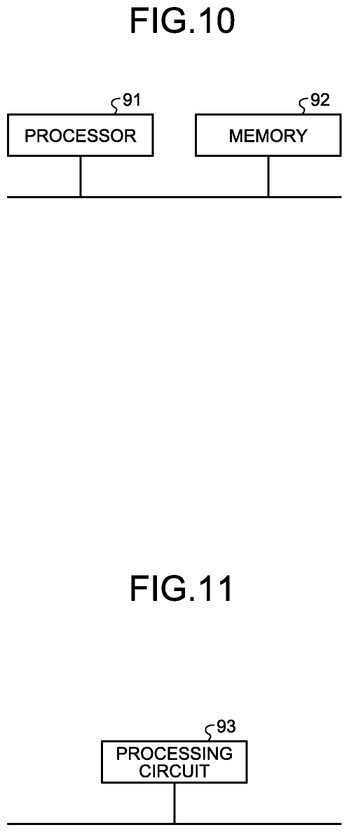

FIG. 10 is a diagram illustrating an example in which the processing circuit included in the TCMS 6 according to the present embodiment is configured with a processor and a memory. When the processing circuit is configured with a processor 91 and a memory 92, functions of the processing circuit of the TCMS 6 are realized by software, firmware, or a combination of software and firmware. The software or the firmware is described as a program and stored in the memory 92. In the processing circuit, the processor 91 reads and executes the program stored in the memory 92, thereby realizing the functions. That is, the processing circuit includes the memory 92 for storing programs by which starting the train 3 to make the train 3 operable, and powering OFF of the vehicle device when stopping the operation of the train 3 are executed as a result. It can also be said that these programs cause a computer to execute procedures and methods of the TCMS 6.

Here, the processor 91 may be a central processing unit (CPU), a processing device, an arithmetic device, a microprocessor, a microcomputer, a digital signal processor (DSP), or the like. The memory 92 corresponds to, for example, a non-volatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disk, or a digital versatile disc (DVD).

FIG. 11 is a diagram illustrating an example in which the processing circuit included in the TCMS 6 according to the present embodiment is configured with dedicated hardware. When the processing circuit is configured with dedicated hardware, the processing circuit 93 illustrated in FIG. 11 corresponds to, for example, a single circuit, a composite circuit, a programmed processor, a parallel programmed processor, an application specific integrated circuit (ASIC), a field programmable gate array (FPGA), or a combination thereof. Functions of the TCMS 6 may be separately realized by the processing circuits 93, or the functions may be collectively realized by the processing circuit 93.

A part of the functions of the TCMS 6 may be realized by dedicated hardware and another part thereof may be realized by software or firmware. Thus, the processing circuit can realize each of the above-described functions by dedicated hardware, software, firmware, or a combination thereof.

The hardware configuration of the TCMS 6 has been described. A hardware configuration of the ATC 5 is similar thereto. In the ATC 5, the communicator 51 is an interface circuit capable of communicating with the OCC 2 and the TCMS 6. The controller 52 is realized by a processing circuit. The processing circuit may similarly be the processor 91 that executes a program stored in the memory 92 and the memory 92 as illustrated in FIG. 10, or may be dedicated hardware as illustrated in FIG. 11.

As described above, according to the present embodiment, the ATC 5 starts the TCMS 6 on the basis of the start instruction from the OCC 2 in the remote control system 1. The TCMS 6 thus started supplies power to each vehicle device. Thus, the remote control system 1 can receive an instruction from the OCC 2 on the ground to make the train 3 operable. In addition, in the remote control system 1, the TCMS 6 stops the supply of power to each vehicle device on the basis of the stop instruction from the OCC 2, and then powers OFF the TCMS 6. Then, the ATC 5 stops the supply of power to the TCMS 6. Thus, the remote control system 1 can receive an instruction from the OCC 2 on the ground to stop the train 3.

The configurations described in the embodiment above are merely examples of the content of the present invention and can be combined with other known technology and part thereof can be omitted or modified without departing from the gist of the present invention.

### REFERENCE SIGNS LIST

1 remote control system; 2 OCC; 3 train; 3-1 to 3-6 vehicle; 4 vehicle starting system; 5, 5-1, 5-6 ATC; 6 TCMS; 7-3, 7-4 direct-current power supply; 8-3, 8-4 BCG; 9-3, 9-4 battery; 10, 10-2, 10-5 pantograph; 11, 11-2, 11-5 VCB; 12-2, 12-5 SIV; 13-1, 13-3, 13-4, 13-6 CI; 14-2, 14-5 main transformer; 15 power converter; 16 vehicle device; 21, 21-1 to 21-6, 21-11 to 21-16 CN; 23, 23-1, 23-6 CCU; 24-1, 24-6 VDU; 25, 25-1 to 25-6, 25-11 to 25-16 RIO; 27 TCMS network; 31, 51 communicator; 52 controller.

1. A vehicle starting system comprising:
an automatic train controller to start an integrated train management system mounted on a train, by controlling to supply power to the integrated train management system from a direct-current power supply on a basis of a start instruction received from a central command device on ground; and
the integrated train management system to perform control to supply power to a first vehicle device, and to further perform control to supply power to a second vehicle device by raising a pantograph and then closing a circuit breaker, and converting a voltage of alternating-current power acquired from an overhead contact line via the pantograph and the circuit breaker.

2. The vehicle starting system according to claim 1, wherein
the integrated train management system comprises:
a first communicator to communicate with the automatic train controller; and
a first controller to, after starting by control of the automatic train controller, supply power from the direct-current power supply to a first power line that supplies power to the first vehicle device, and to further supply power to the second vehicle device by raising the pantograph, closing the circuit breaker, and causing a power converter to convert a voltage of alternating-current power acquired from the overhead contact line via the pantograph and the circuit breaker.

3. The vehicle starting system according to claim 2, wherein
the automatic train controller comprises:
a second communicator to receive the start instruction from the central command device; and
a second controller to, when the start instruction is received by the second communicator, supply power from the direct-current power supply to a second power line that supplies power to the integrated train management system.

4. The vehicle starting system according to claim 3, wherein
in a case where a stop instruction is transmitted from the central command device,
when the first controller acquires the stop instruction via the second communicator and the first communicator, the first controller stops supply of power to the second vehicle device by opening the circuit breaker to stop a conversion process performed by the power converter, lowers the pantograph, and further stops supply of power from the direct-current power supply to the first power line to thereby stop an operation of the integrated train management system, and
after the operation of the integrated train management system is stopped, the second controller stops supply of power from the direct-current power supply to the second power line.

5. A remote control system comprising:
the vehicle starting system according to claim 4; and
a central command device to transmit a start instruction and a stop instruction to the vehicle starting system.

6. An integrated train management system that constitutes a vehicle starting system together with an automatic train controller, the integrated train management system comprising:
a first communicator to communicate with the automatic train controller; and
a first controller to, when starts by control of the automatic train controller received a start instruction from a central command device on ground, supply power from a direct-current power supply to a first power line that supplies power to a first vehicle device, and to further supply power to a second vehicle device by raising a pantograph, closing a circuit breaker, and causing the power converter to convert a voltage of alternating-current power acquired from an overhead contact line via the pantograph and the circuit breaker.

7. The integrated train management system according to claim 6, wherein
in a case where a stop instruction is transmitted from the central command device on ground,
when the first controller acquires the stop instruction via the automatic train controller and the first communicator, the first controller stops supply of power to the second vehicle device by opening the circuit breaker to stop a conversion process performed by the power converter, lowers the pantograph, and further stops supply of power from the direct-current power supply to the first power line to thereby stop an operation of the integrated train management system.

8. An automatic train controller that constitutes a vehicle starting system together with an integrated train management system, the controller comprising:
a second communicator to receive a start instruction from a central command device on ground; and
a second controller to, when the start instruction is received by the second communicator, supply power from a direct-current power supply to a second power line that supplies power to the integrated train management system.

9. The automatic train controller according to claim 8, wherein
in a case where a stop instruction is transmitted from the central command device,
after an operation of the integrated train management system is stopped, the second controller stops supply of power from the direct-current power supply to the second power line.

10. (canceled)
